(19) United States
(12) Patent Application Publication
(10) Pub. No.: US 2020/0180164 A1
(43) Pub. Date: Jun. 11, 2020

(54) SANDWICH STACKER

(71) Applicant: Technology Brewing Corporation, Salmon Arm (CA)

(72) Inventors: Michael Howard Boudreau, Salmon Arm (CA); James Boyd Gibson, Salmon Arm (CA); Kyle Andrew Flatman, Salmon Arm (CA); Kyran Ashley Lawrence Findlater, Salmon Arm (CA); Robin Michael McCaffrey, Salmon Arm (CA)

(21) Appl. No.: 16/211,570

(22) Filed: Dec. 6, 2018

(51) Int. Cl. B25J 15/00; B25J 15/02

(52) U.S. Cl. CPC B25J 15/0014; B25J 15/02

(57) ABSTRACT

A sandwich stacker for grasping, rotating and stacking one half of a bisected sandwich on the other half. The stacker includes a half-sandwich gripper. A selectively actuable rotator is coupled to the gripper. The gripper is adapted to releasably hold a first half-sandwich of a bisected sandwich. The rotator selectively rotates the gripper about a first axis of rotation for stacking the first half-sandwich on the other half of the sandwich. The stacker is adapted to be coupled to a positioning device, such as a robotic arm. The rotator may be mounted on the stacker or on the positioning device. The first axis of rotation may be through a center of mass of the first half-sandwich when held by the gripper, or through a cut-line bisecting the bisected sandwich when the first half-sandwich is first held by the gripper.

### FIELD

The present invention relates to a sandwich stacking device used in sandwich production lines, wherein two halves of transversely bisected sandwiches are stacked vertically, one half on top of the other with aligned edges for packaging. The invention further relates to a sandwich production line containing such a device.

### BACKGROUND

Conventionally packaged sandwiches are processed in mass production lines, where a two-bread slice sandwich is first assembled as a top and bottom slice with the sandwich ingredients between. The two bread slice sandwich is then cut diagonally and each separated half manually stacked in a triangular deck with one triangular half lying flush on the other triangular half, with the diagonal edges aligned. The resulting stack is then wrapped for shipment and sale.

In the prior art, applicant is aware of published European Patent Application 1591013 A1 titled “Sandwich stacking device as well as sandwich production line comprising such device”, by Bosgraaf Apparaten B.V., published Nov. 2, 2005. A sandwich production line is described using a sandwich stacking device. The stacking device lifts and rotates both halves of the sandwich using slotted paddles. Applicant is also aware of UK Patent 2400536 (A) titled “Apparatus for the Automatic Production of Sandwiches”, which issued on Mar. 7, 2006. A sandwich production line is described that separates sandwich halves, rotates one half 180 degrees by use of a vacuum paddle and powered by a stepper drive, then stacks the halves in triangle formation.

### SUMMARY

The present stacker stacks sandwiches in a production line. The stacker provides the means to quickly grasp, rotate, and stack one half of a triangularly or diagonally bisected sandwich on the other half. The sandwich stacker is mountable to a variety of motion and positioning devices (collectively herein referred to as positioning devices) such as, for example, a robotic arm, delta robot, gantry or servo actuator array so as to obtain lifting of one sandwich half relative to the other. The present sandwich stacker then rotates and deposits the lifted sandwich half onto the lower sandwich half so as to align the edges of both sandwich halves

Thus in one embodiment the present sandwich stacker, in conjunction with a positioning device, stacks bisected square sandwiches using a catch-lift-rotate-release technique. The sandwich half (S1) to be lifted is picked up for rotation a gripping assembly by first lowering a hold down plate over sandwich half (S1), thereby securing sandwich half (S1) in position with a hold-down force applied by the hold down plate. The sandwich stacker then grips sandwich half (S1), readying it for lifting and rotation, by swinging a sandwich gripper assembly, which includes a pair of wings and spatulas, radially in to position the spatulas under sandwich half (S1), thereby, securing sandwich half (S1) laterally within the corresponding support wings. The spatulas extend substantially orthogonally from the support wings and are co-planar with one another. The pair of spatulas slide under sandwich half (S1) as the wings swing into their lateral support positions. With the sandwich stacker's lifting spatulas thus beneath sandwich half (S1), the positioning device then lifts the sandwich stacker, which lifts sandwich half (S1) to an elevation slightly above an uppermost surface of the remaining second bisected sandwich half (S2). Once sandwich half (S1) has been so lifted, sandwich half (S1) is carried on the pair of spatulas, additionally supported by a pair of lateral support wings on the spatulas and by the hold down plate to secure sandwich half (S1) during rotation. During the rotation, the bread slices and sandwich filler between the bread slices in the sandwich half (S1) is laterally supported by the lateral support wings, and rotated by a rotation assembly approximately 180 degrees to align sandwich half (S1) vertically above sandwich half (S2). The spatulas and support wings are then swung out and away from sandwich half (S1), which then drops vertically onto sandwich half (S2). Sandwich half (S1) is urged downwardly by the hold down plate to both suppress rebound of sandwich half (S1), and to hold sandwich half (S1) in place resting on sandwich half (S2).

The positioning device then lifts the sandwich stacker to clear the gripping assembly over the upper surface of sandwich half (S1). The gripping assembly rotates back to its ready position, ready for lowering over the next sandwich to be assembled.

### BRIEF DESCRIPTION OF THE DRAWINGS

FIG. 1 is an isometric view of sandwich stacker (X1).

FIG. 2 is a front-perspective view of sandwich stacker (X1).

FIG. 3 is a side-perspective view of sandwich stacker (X1).

FIG. 4 is a back-perspective view of sandwich stacker (X1).

FIG. 5 shows the rotation assembly (X2)

FIG. 6 shows the sandwich gripping assembly (X3)

FIGS. 7-12 show the sandwich stacker in operation, including one embodiment of a two bread slice sandwich by way of example, wherein:

FIG. 7 shows the sandwich stacker being lowered over sandwich half S1, and applying hold down plate holding pressure.

FIG. 8 shows the sandwich stacker's gripping assembly clamping the sandwich for lifting and rotation.

FIG. 9 shows the sandwich stacker with the sandwich clamped between lifting spatulas and hold down plate, guided laterally by support wings, and lifted into position ready for rotation.

FIG. 10 shows the rotation assembly's rotation to align the lifted sandwich half over the remaining sandwich half.

FIG. 11 shows sandwich stacker releasing the lifted sandwich half onto the top of the remaining sandwich half, to create the sandwich stack.

FIG. 12 shows rotation assembly's rotation rotating the gripping assembly back to its starting position so that it is ready to act upon next sandwich presented.

FIG. 13 shows sandwich stacker in an example embodiment, mounted as an end effector to a 6-axis robotic arm.

FIG. 14 is, in front perspective view, a second embodiment of the sandwich stacker with the sandwich support wings in their open position.

FIG. 15 is the view of FIG. 14 with the sandwich support wings in their closed position gripping one half of a pre-cut sandwich.

FIG. 16 is the sandwich stacker of FIG. 14 in rear perspective view.

FIG. 17 is the sandwich stacker of FIG. 16 in left side elevation view.

FIG. 18 is the sandwich stacker of FIG. 16 in rear elevation view showing in cross section the crank arms actuating the support wings.

FIG. 19 is a further embodiment of the gripping assembly.

FIG. 20a is a plot of one example of displacement in degrees of rotation of gripping assembly (x3) versus time for 180 degree rotation of a sandwich half (S1).

FIG. 20b is the velocity profile over time corresponding to the example of FIG. 20a.

FIG. 20c is the acceleration/deceleration profile over time corresponding to the example of FIG. 20a.

FIG. 20d is the rate of change of acceleration/deceleration profile over time corresponding to the example of FIG. 20a.

### DETAILED DESCRIPTION OF THE INVENTION

In what follows, multiple embodiments of the sandwich stacker are described in conjunction with references to the drawings wherein like reference numerals denote corresponding parts in each view. The description of the embodiments is not intended to be limiting.

The sandwich stacker (X1) according to a first embodiment is intended for use in a sandwich production line, but the invention is not so limited. Stacker (X1) is for example mounted on the distal end of a positioning device such as a gantry or robotic appendage including a robotic arm. The gripping, elevating and rotating mechanism of stacker (X1) provides for automatic stacking of sandwich halves as better described below. The gripping assembly provides for stable lifting, rotating, and lowering of a sandwich half as better described below.

Sandwich stacker (X1) in one embodiment, not intended to be limiting, mounts onto the positioning device using a mounting plate (1). Mounting plate (1) is but one example as the mounting may be accomplished by, for example, tool changers, an angle bracket, suction plate, clip lock or other mounting apparatus that would be known to one skilled in the art.

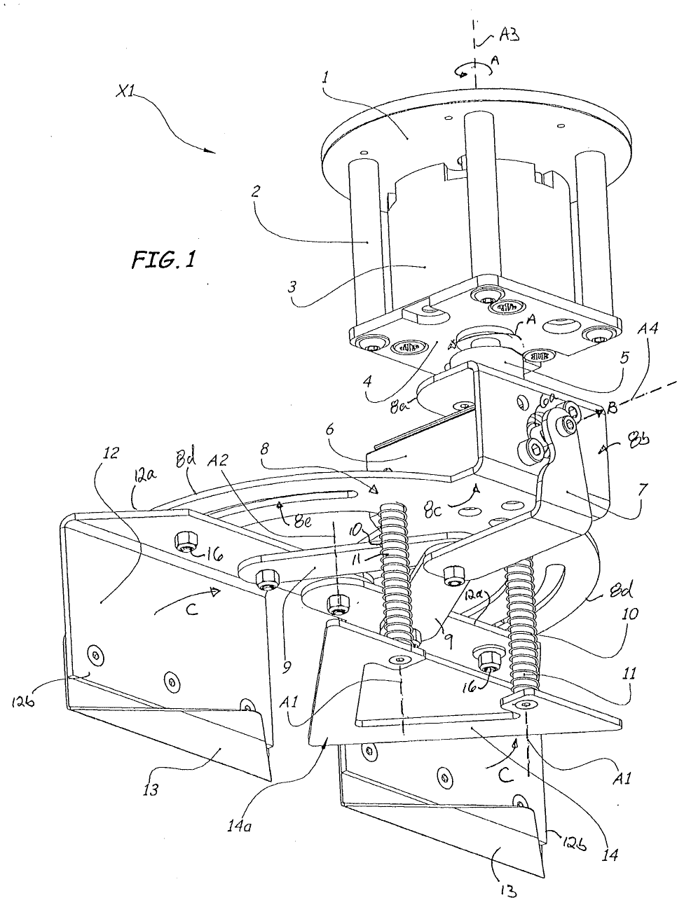

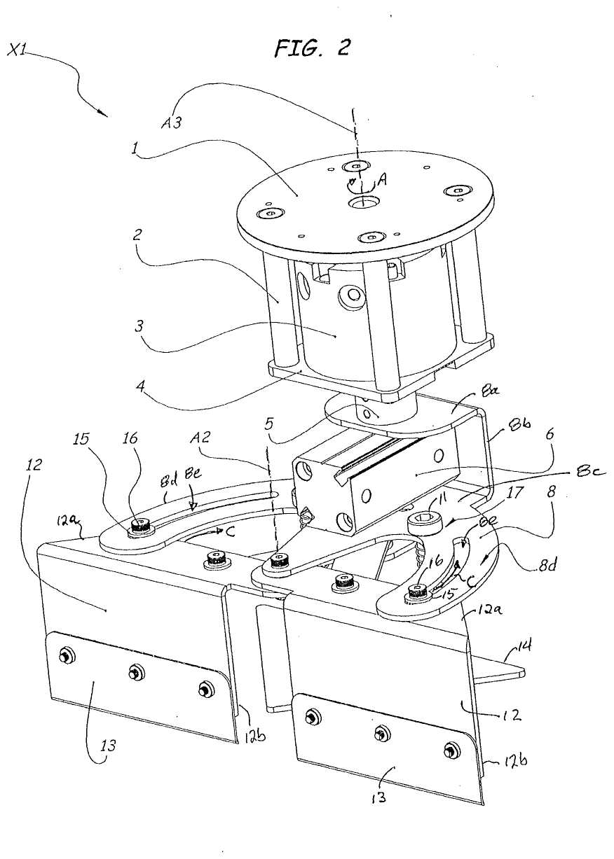

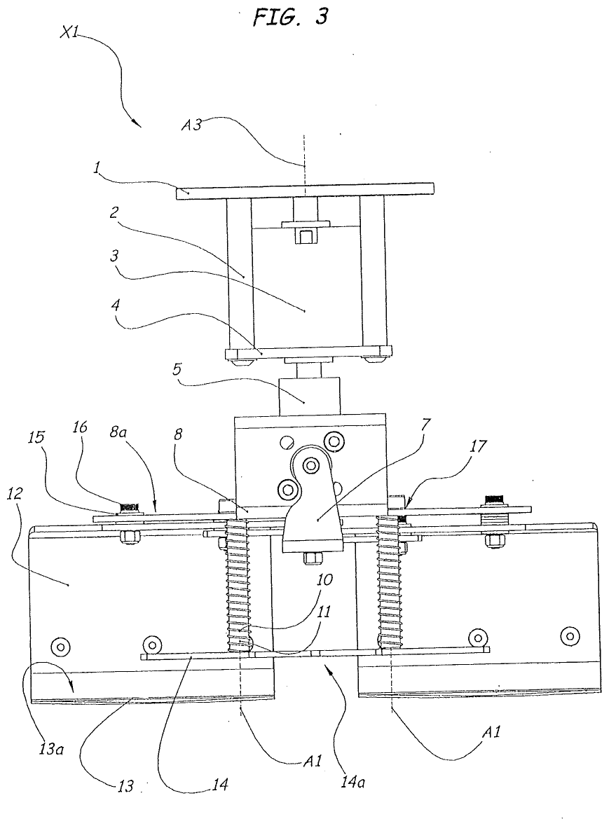

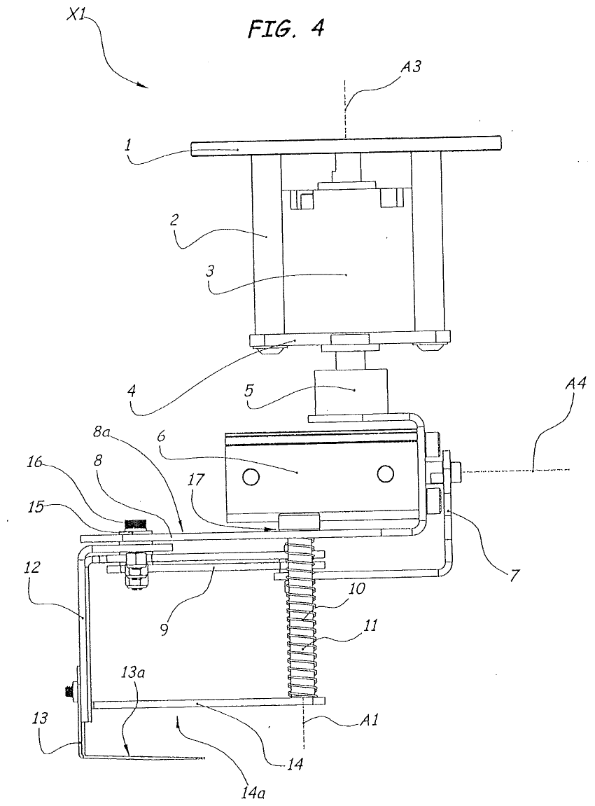

As seen in FIGS. 1-6, stand-off posts (2) provide a frame for rotary actuator (3) mounted between plate (1) and rotary actuator mounting plate (4). Rotary actuator coupler (5) mounts rotary actuator (3) to upper flange (8a) of support plate (8) so that, upon rotary actuation of rotary actuator (3), support plate (8) rotates in direction A about axis A3. Upper flange (8a), force plate (8b), and lower flange (8c) form an enclosure within which linear actuator (6) is mounted. Linear actuator (6) may be mounted to face plate (8b) for linear actuation of a drive shaft (6a) in direction B along axis A4.

Linkage member (7) is mounted on the end of drive shaft (6a) so that it is also driven in direction B upon actuation of linear actuator (6). Linkage member (7) and a pair of linkage arms (9) form a scissor linkage such that, as linkage member (7) is driven in direction B, the ends of linkage arms (9) distal from linkage member (7) are pulled and drawn together, drawing with them a corresponding pair of support wings 12 pivotally mounted for butterfly folding together of wing 12 in directions C about axis A2. During folding rotation, wings 12 are supported on wing support arms (8d). In the illustrated embodiment, again not intended to be limiting, support bolts (16) and corresponding bearings (15) support wing flanges (12a) up under wing support arms (8d), and slidingly follow along and in arcuate channels (8e) formed along the lengths of wing support arms (8d).

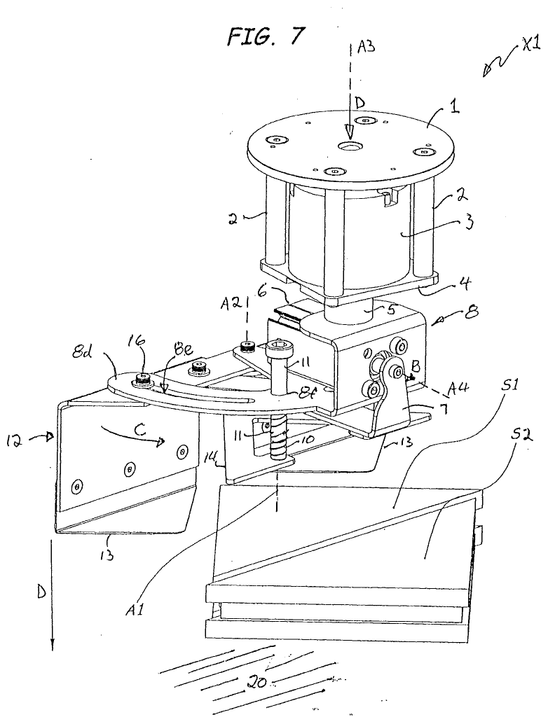

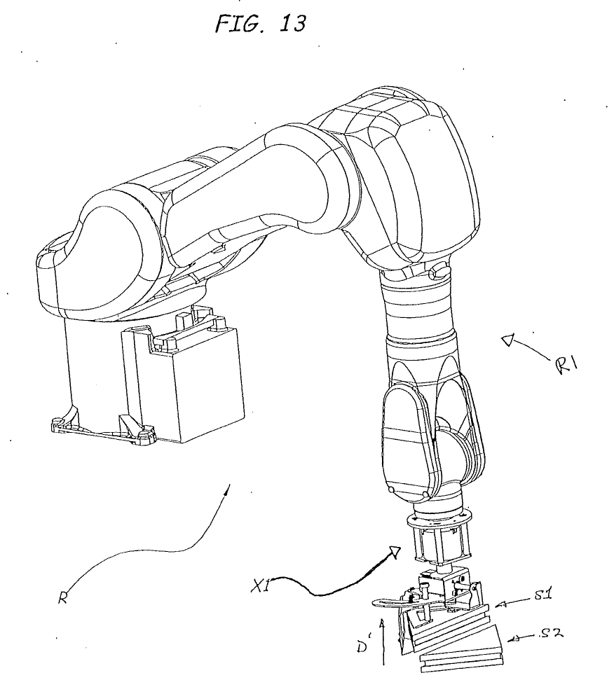

Once sandwich stacker (X1) is positioned over a sandwich half (S1) to be stacked by a positioning device such as robotic arm (R), seen by way of example in FIG. 13, stacker (X1) is lowered onto sandwich half (S1) so that hold down plate (14) is gently pressed onto sandwich half (S1). Sandwich half (S1) is the sandwich half to be lifted, rotated, and placed down onto the remaining, stationary, sandwich half (S2). Hold down plate (14) may be triangular in shape as illustrated to conform in plan form shape to sandwich half (S1). Hold down plate 14 may be resiliently suspended, as illustrated, on spring-loaded shafts (11). Shafts (11) are rigidly mounted to plate (14), and are slidingly mounted through holes (8f) in lower flange (8c) of support bracket (8) and bushings (17). As stacker (X1) is lowered in direction D (FIG. 7) compressing plate (14) onto sandwich half (S1), springs (10) compress as shafts (11) are pushed up along axes (A1) through bushings (17) as seen in FIG. 7. Sandwich half (S1) is thus gently immobilized down onto the factory conveyor or other support surface (20), such as seen in FIG. 7. Lifting spatulas (13) are mounted or formed along the lower edges (12b) of lateral support wings (12), and extend cantilevered orthogonally therefrom. Preferably spatulas (13) are thin and may preferably be triangularly shaped and co-planar with one another. Once stacker (X1) has been lowered, wings (12) close in directions C following arcuate channels (8e). Once in the fully folded-closed positions the spatulas (13) abut, or are adjacent each other and are co-planar, so as to substantially fully support the underside of sandwich half (S1), interleaved between sandwich half (S1) and support surface (20).

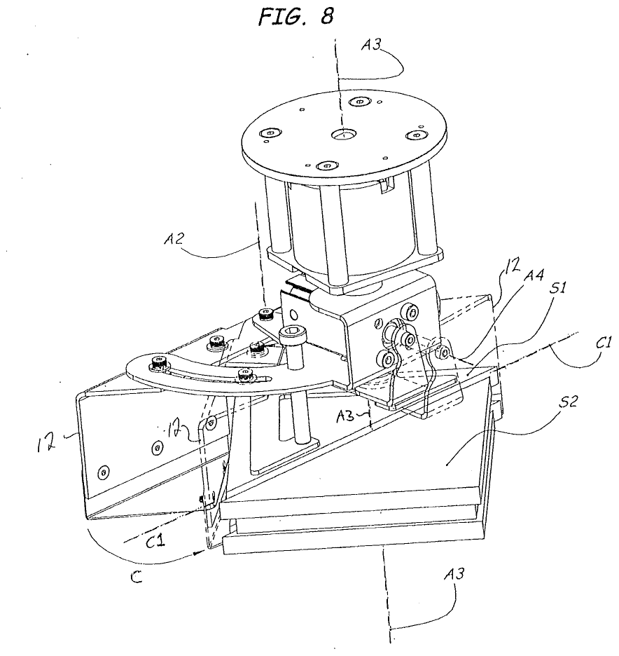

As seen in FIG. 8, the sandwich stacker (X1) is shown in dotted outline gripping or clamping sandwich half (S1). In this first embodiment, not intended to be limiting, the axis of rotation A3 is substantially aligned to intersect sandwich cut line (C1) bisecting through the center of sandwich (S1, S2). Sandwich half (S1) is compressed by plate (14) with wings (12) in their fully open position. With hold down plate (14) holding gentle pressure down to sandwich half (S1), linear actuator (6) is actuated to drive linkage member (7) in direction B along axis A4. As described above, this translates linear movement of linkage member (7) to rotational movement of wings (12) via the linkage arms (9). The support wings (12) rotate in direction C about axis A2, which closes support wings (12) to their closed position shown in dotted outline, snugged laterally against the corresponding sides of sandwich half (S1), and simultaneously slides lifting spatulas (13) under sandwich half (S1). The sandwich half (S1) is now supported top and bottom, and laterally on two of three sides, and thus ready for, first, lifting, and then rotation. The sandwich gripper assembly, including wings (12) and spatulas (13), is supported throughout the opening and closing of the gripping assembly (X3) by wing-support bolts (16), travelling along channels 8e and supported by support arms 8d.

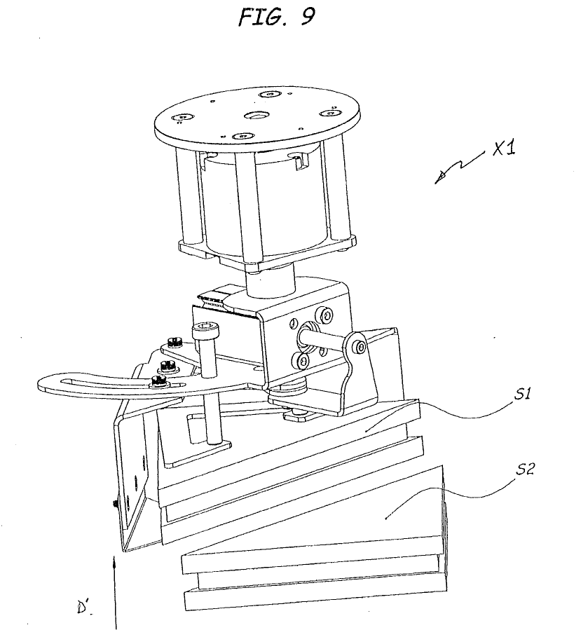

As seen in FIG. 9, once sandwich half (S1) has been gripped, the sandwich stacker (X1) and sandwich half (S1) are elevated in direction D′ (opposite to direction D), by the operation of a positioning device such as robotic arm (R) as seen in FIG. 13. Sandwich half (S1) is lifted on their upper surfaces (13a) of spatulas (13).

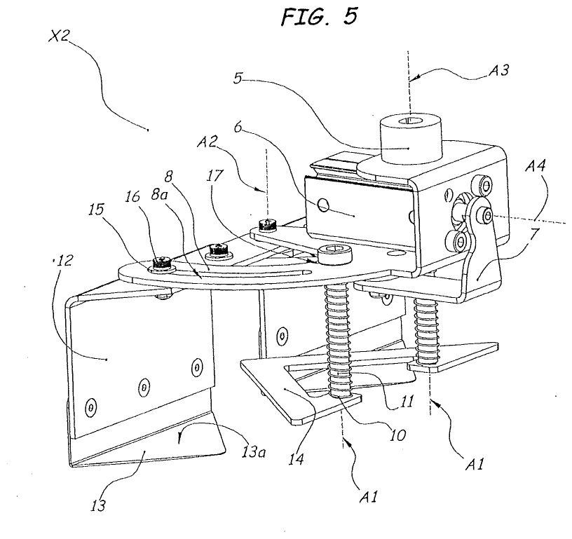

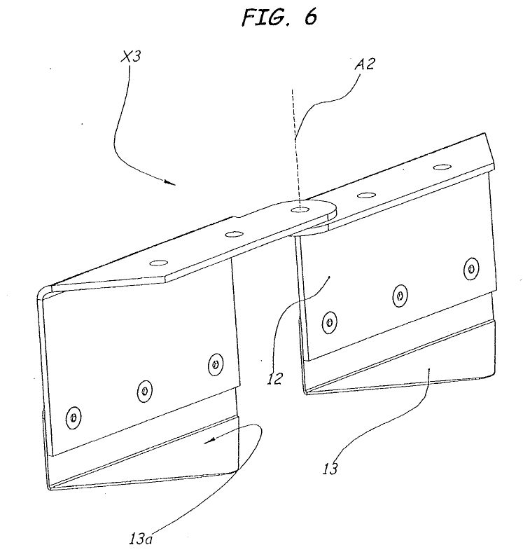

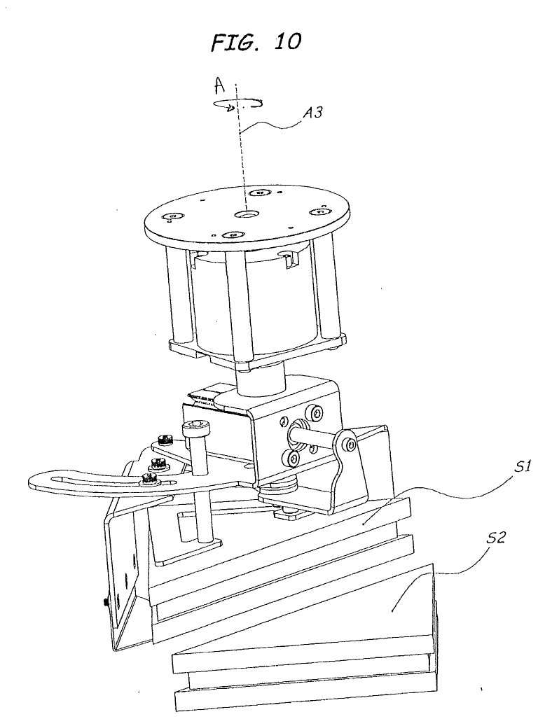

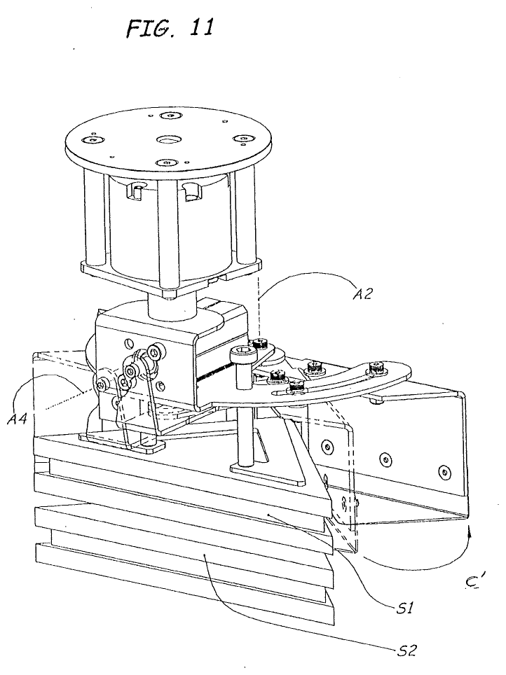

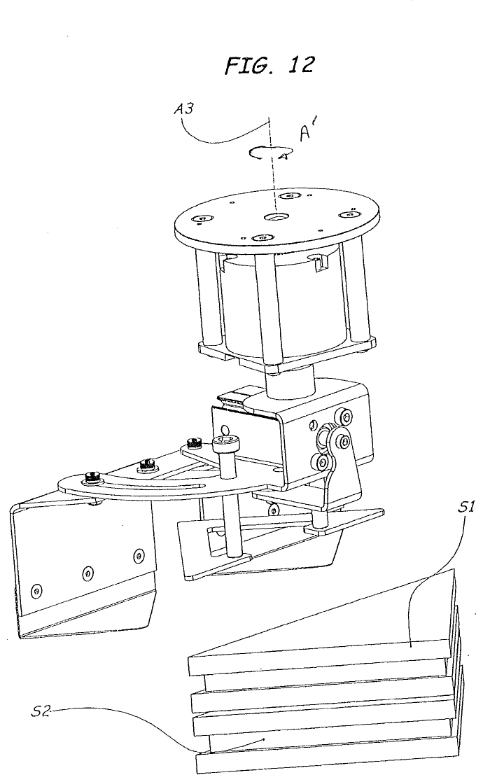

As seen in FIG. 10, once sandwich half (S1) and the gripping assembly (X3), shown isolated in FIG. 6, has been elevated above, so as to clear, sandwich half (S2) which remains resting on support surface 20, rotation assembly (X2), seen isolated in FIG. 5, rotates the gripping assembly and sandwich half (S1) about axis A3 in direction A by means of rotary actuator (3). The use of rotary actuator (3) is not intended to be limiting as rotation may also be accomplished by other means, for example a linear actuator translating linear movement into a rotational movement, robot wrist rotation using robotic arm (7), or any other method of producing required rotational movement. Rotation in direction A rotates sandwich half (S1) 180 degrees from its initial orientation in opposed facing relation to sandwich half (S2) as seen in FIG. 7, into its ready-to-be-stacked position aligned over sandwich half (S2) as seen in FIG. 11, ready to be dropped into the stacked formation of FIG. 12.

As seen in FIG. 11, the sandwich stacker (X1) drops sandwich half (S1) onto sandwich half (S2) by removing spatulas (13) from under sandwich half (S1). This is actuated by retracting linear actuator (6) along axis A4, which pulls in linear actuator linkage (7), which in turn translates that linear translation of the scissor linkage to rotational opening movement of support wings (12) and spatulas (13) via the linkage arms (9). As the support wings (12) open from their closed position supporting sandwich half (S1), lifting spatulas (13) are slid out from under sandwich half (S1). Once spatulas (13) are clear, sandwich half (S1) then drops down on to sandwich half (S2) urged by gravity and hold down plate (14). Plate 14 presses its under surface (14a) down onto sandwich half (S1) as springs (10) resiliently expand along hold down plate shafts (11).

As seen in FIG. 12, the sandwich stacker (X1) then rotates gripper assembly (X3) about axis A3 in direction A′ (opposite to direction A) by reverse actuation rotary actuator (3). Rotation in direction A′ returns the rotation and gripping assemblies to their original waiting position ready for the next sandwich half (S1) to be gripped, lifted, rotated, and released down onto the corresponding sandwich half (S2).

Although support wings (12) and lifting spatulas (13) are depicted as two separate components, with one mounted to the other to form the gripper assembly (X3), one skilled in the art will understand that they may be formed as a unitary component.

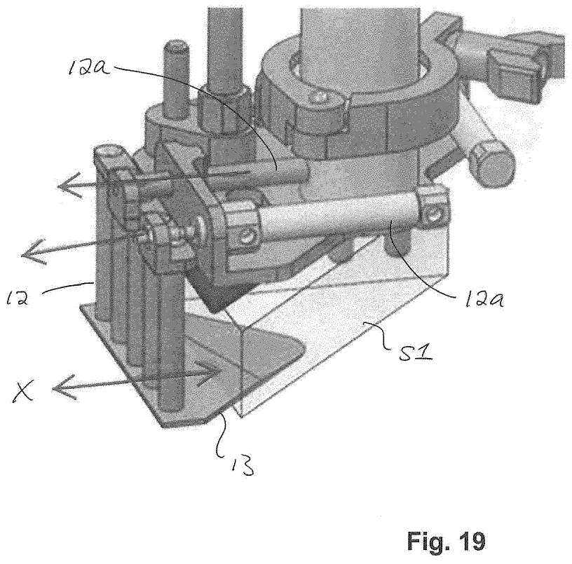

Possible other variations include but are not limited to: positioning means by various robot types, servos, gantry; rotational means by robot wrist, rotary servo, rotary actuators; support wings could be replaced with parallel linkage to bring lifters in parallel to edge faces of sandwich, static support wings with spatula lifters that rest behind the support wings, then actuate out beneath the sandwich once in place; hold down plate can be spring, pneumatic, solenoid, servo actuated; profile of hold down plate can be totally enclosed, radiused edged (large), profiled with a step to engage the body and the crust of the bread at different elevations. As seen in FIG. 19, there are other embodiments for actuation of the wings (12) and spatulas (13). FIG. 19 illustrates use of linear actuators 12a to linearly translate one or more wings (12) and spatulas (13) for sliding in direction X under, and removal from under, sandwich half (S1).

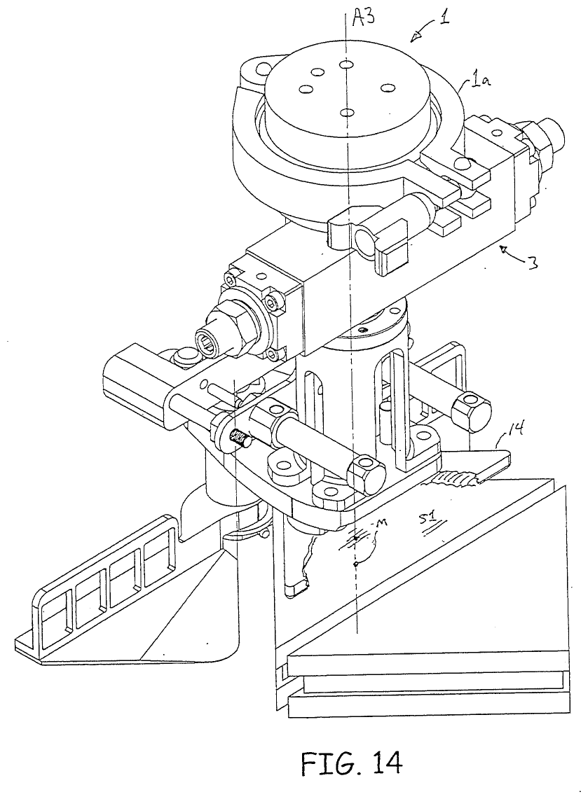

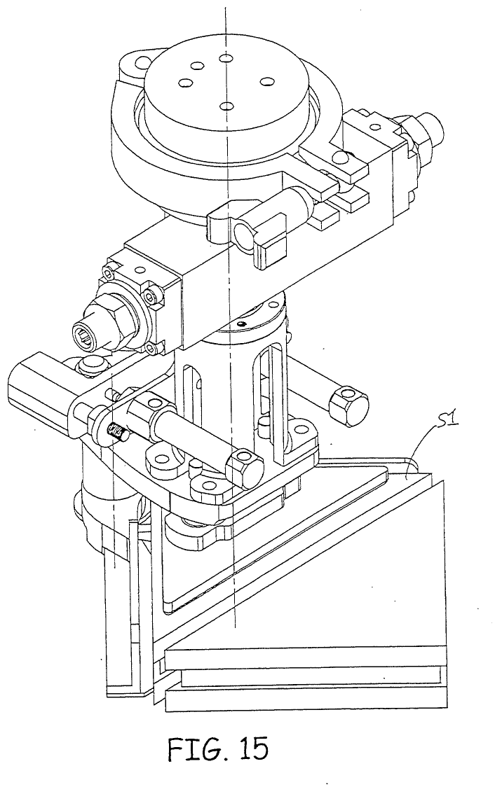

In some situations, it has been found that the filler in a sandwich (S1, S2), when it is for example of particulate matter or viscous matter, may be flung from between the slices of bread in the sandwich during rotation of sandwich half (S1), especially where, due for example to the speed of the conveyor, that the rotation speed rotating half sandwich (S1) is necessarily relatively high. Where the sandwich filler has a propensity to be driven out centripetally from between the slices of bread, and in particular where the rotation speed for rotating sandwich half (S1) is high, it has been found useful to alter the geometric arrangement of sandwich stacker (X1) so that the axis of rotation A3 intersects sandwich half (S1) through its centre of mass rather than intersect the sandwich cut line (C1). As seen in FIG. 8, in the first embodiment, axis A3 intersects cut line (C1) which then positions the entire mass of sandwich half (S1) between axis A3 and the vertex or folding axis A2 of wings (12). In the second and preferred embodiment, axis A3 intersects substantially the centre of mass (M) of sandwich half (S1) as seen in FIGS. 14 and 15. Moving axis A3 so as to intersect the centre of mass (M) of sandwich half (S1) reduces the inertia and therefore the amount of torque required of rotary actuator 3 in order to quickly rotate sandwich half (S1) when cradled within the gripping assembly (X3). Moving the axis of rotation A3 to the centre of mass (M) also reduces the tendency of viscous or particulate sandwich fillings to be flung outwardly from between the slices of bread in sandwich half (S1) during rotation.

The illustrations of the second embodiment of sandwich stacker (X1) seen in FIGS. 14-18 also illustrate structural variance as compared to the first embodiment of FIGS. 1-13 which, in any event, accomplish the same, if not improved, functionality.

Thus mounting plate 1 in the second embodiment incorporates upper and lower halves releasably coupled together by a removable collar (1A) which provides for a quick release of sandwich stacker (X1) from, for example, the robotic wrist of robotic arm (R).

Rotary actuator (3) in the second embodiment may be a hydraulically driven actuator, which replaces the pneumatically driven actuator of the first embodiment. An electrically driven actuator may also be used. Alternatively, a robotic wrist may provide all of the rotation so as to give adequate torque, so that a separate rotary actuator 3 is not required. The rotational movement may be implemented using a combination of a robotic joint or wrist (R1) rotation, and rotation by a rotary actuator 3. The rotary actuator motion may be damped at its limits by shock absorbers (not shown) to assist deceleration of the end effector to prevent shock and centripetal flinging of the sandwich ingredients between the slices of bread upon completion of rotation.

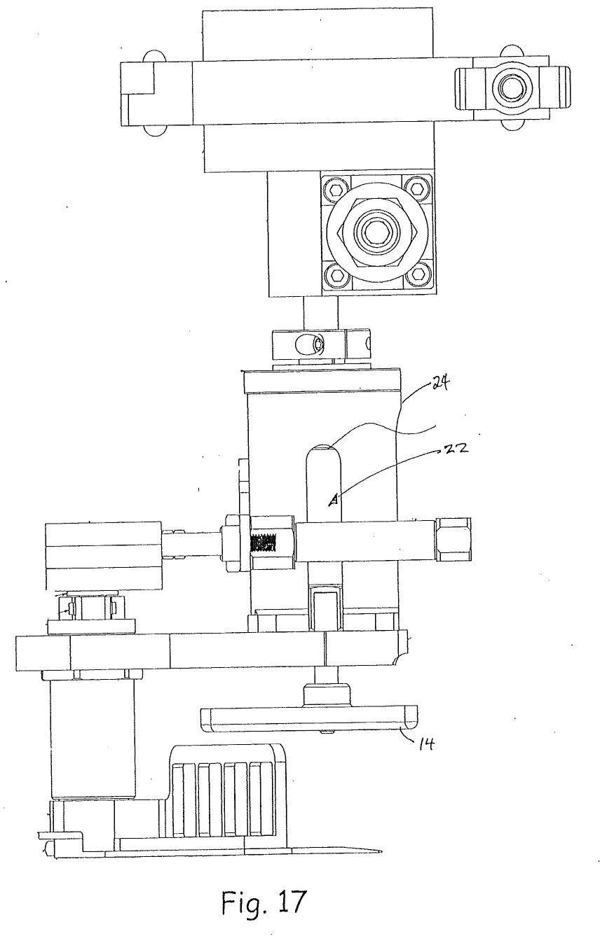

In the second embodiment, hold down plate (14) is resiliently downwardly urged by a piston, or pair of pistons (22) as seen in FIG. 17. Piston (22) operates vertically and is supported within housing (24).

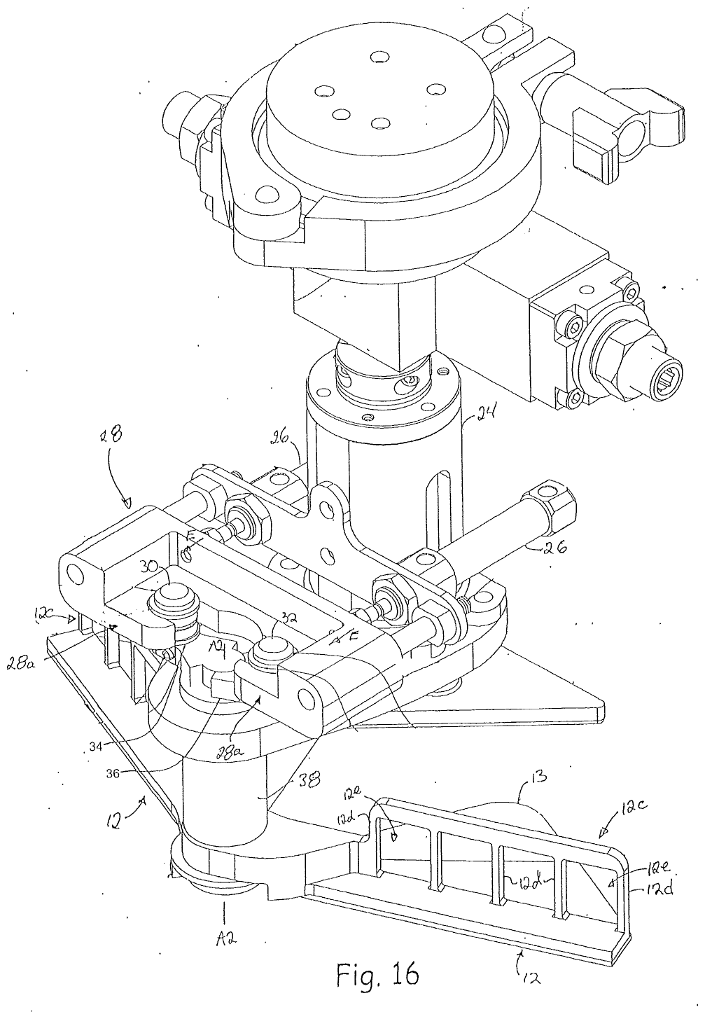

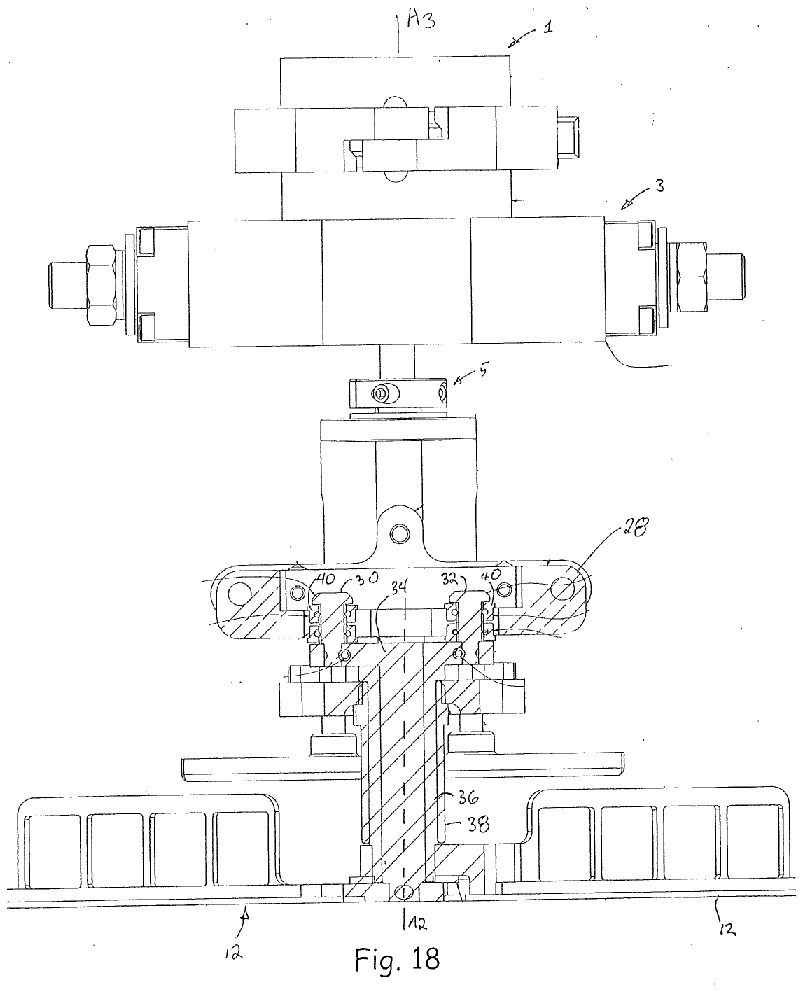

The scissor linkage actuated by linear actuator (6) via linkage number (7) in the first embodiment is replaced by the operation of a pair of linear actuators (26) mounted horizontally on opposite sides of housing (24). Actuators (26) simultaneously drive a yoke (28) which converts the linear translation from the linear actuators (26) to the rotational butterfly-folding of wings (12) about axis A2. In particular, yoke (28) engages the upright stub shafts (30) and (32) of corresponding crank arms (34) and (36) respectively so as to drive rotation of the pair of wings (12) about axis A2. Thus yoke (28) pushing or pulling on stub shaft (30) thereby actuates crank arm (34) on which stub shaft (30) is mounted to rotate the corresponding wing (12), being the left hand wing (12) in the cross-sectional view of FIG. 18. The right hand wing (12) is rotated by yoke (28) acting on stub shaft (32) to thereby rotate crank arm (36). Crank arms (34) and (36) are coaxially nested within a cylindrical housing (38) so that both crank arms (34) and (36) rotate about axis A2. The coaxial drive using crank arms 34, 36 simplifies the picking and rotation of the sandwich half (S1) by making the contact forces radial and symmetrical. Because stub shafts (30) and (32) are retained within yoke collars (28A) of yoke (28), being rotatably retained therein within bushings (40), actuation of linear actuators (26) in direction E causes yoke (28) to push on stub shafts (30, 32). This simultaneously rotates crank arms (34, 36) respectively, thereby opening or unfolding wings (12) into their open-most position seen in FIG. 16. Retraction of yoke (28) by the reverse actuation of linear actuators (26) causes yoke (28) to pull on stub shafts (30, 32) thereby simultaneously rotating crank arms (34, 36) to fold wings (12) about axis A2 from their open position to their closed position seen in FIG. 15.

Wings (12) are of a modified design in the second embodiment as compared to the first embodiment in that, instead of the use of plates which extend upwardly from spatulas (13), each wing (12) instead has a fence (12C). Each fence (12C) includes a plurality of uprights (12D), the illustrated embodiment including five uprights (12D) interspersed between relatively large apertures (12E). The use of fences (12C) reduces the sticking of the sandwich filler to wings (12) when in their closed position gripping, sandwich half S1.

Upon activating the rotary actuator, the gripping assembly and sandwich half (S1) experiences rotational acceleration up until either a peak velocity of the rotary actuator is reached or until a shock absorber mounted inside the rotary actuator is activated. The shock absorber will be activated upon rotation of a preset angle of the gripping assembly and the negative acceleration it applies on the gripping assembly and sandwich half (S1) allow the rotational velocity to diminish before impacting the end of the rotary actuation. By using a shock absorber, the rotational acceleration at the end of the cycle is spread out over a longer time frame and does not peak as high. This allows for a softer, less damaging grip on the sandwich half (S1), as well as increases the lifespan of the end effector.

By way of example, during testing applicant has achieved 180 degree rotation of sandwich half (S1) in gripping assembly (x3) in 0.14 seconds. Analysis determined that angular acceleration by the rotating actuator occurred the first 0.11 seconds (covering an arc of 134 degrees) and that deceleration due to resistance caused by the damper or shock absorber occurred during the remaining 0.03 seconds (covering the remaining arc from 134 degrees to 180 degrees).

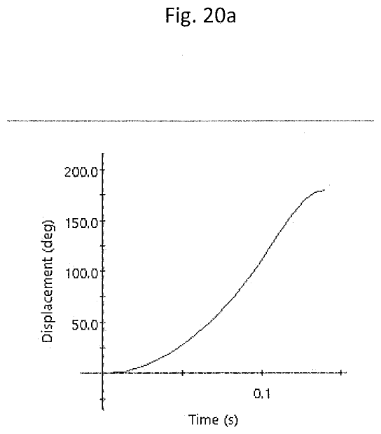

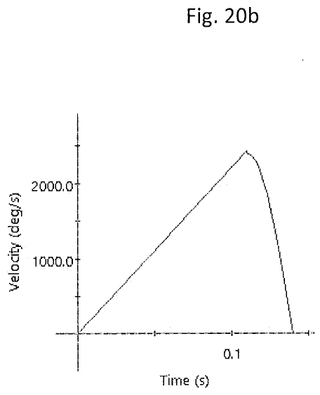

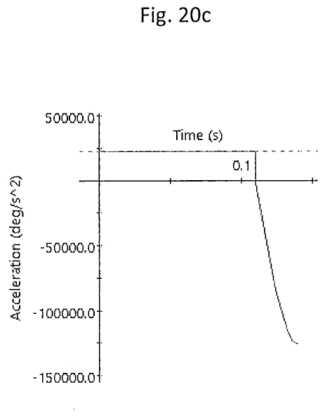

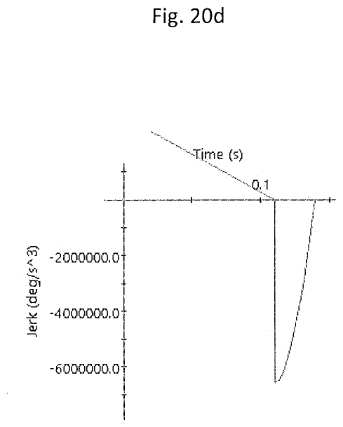

A corresponding representation of the rotation of gripping assembly (x3) is illustrated in FIG. 20a which depicts the angular displacement in degrees over the time of travel between zero and 180 degrees displacement.

FIGS. 20b, 20c and 20d show the corresponding velocity, acceleration/deceleration, and rate of change of acceleration (jerk) profiles.

This process is duplicated in reverse when returning the end effector to its original state, only without the bisected sandwich half (S1). By implementing electrical servo control of the rotation as is the case with joint (R1) of a six degree of freedom robotic wrist, the acceleration and deceleration profiles can be controlled and thereby eliminate the need for further shock absorption. Ideally the acceleration and deceleration profiles enable rotating the sandwich half (S1) in the shortest period of time that minimizes the centripetal acceleration and deceleration that would cause the sandwich ingredients; i.e. filling, to become dislodged or to be flung from the sandwich half (S1).

As will be apparent to those skilled in the art in the light of the foregoing disclosure, many alterations and modifications are possible in the practice of this invention without departing from the spirit or scope thereof.

What is claimed is:

1. A sandwich stacker comprising:
a half-sandwich gripping assembly which includes at least one spatula and at least one lateral support wing, wherein the gripping assembly is adapted for mounting to a selectively actuable rotator,
and wherein the gripping assembly is adapted to releasably hold a first half-sandwich of a bisected sandwich and to be rotated about a first axis of rotation, and wherein the rotator when coupled to the gripping assembly selectively rotates the gripping assembly about the first axis of rotation.

2. The stacker of claim 1 wherein the first axis of rotation intersects a center of mass of the first half-sandwich when held by the gripping assembly.

3. The stacker of claim 1 wherein the first axis of rotation intersects a cut-line bisecting the bisected sandwich when the first half-sandwich is first held by the gripping assembly

4. The stacker of claim 1 further comprising the rotator coupled to the gripping assembly and an end effector mount cooperating with and coupled to the rotator, wherein the mount is adapted to couple to an end of a positioning device.

5. The stacker of claim 4 further comprising the positioning device; and wherein the positioning device is adapted to selectively elevate the rotator and gripping assembly above a remaining half-sandwich of the bisected sandwich when the first-half-sandwich is held by the gripping assembly so that the first half-sandwich and gripping assembly is rotatable by the rotator to align the gripping assembly over, so as to cover, the remaining half-sandwich with the first half-sandwich.

6. The stacker of claim 1 wherein the at least one lateral support wing includes a selectively foldable pair of support wings.

7. The stacker of claim 6 wherein one of the at least one spatulas is mounted on each wing of the pair of support wings.

8. The stacker of claim 7 wherein each wing of the pair of support wings includes a lateral support to support a corresponding side of the first half-sandwich.

9. The stacker of claim 8 wherein each of the spatulas extends orthogonally from a corresponding said lateral support on each of the support wings.

10. The stacker of claim 9 wherein the pair of support wings are actuatable between open and closed positions wherein, in the open position, the spatulas are removed from under the first half-sandwich, and wherein, in the closed position, the spatulas are positioned under the first half-sandwich.

11. The stacker of claim 10 wherein the spatulas are sized so that, when the pair of support wings are in their closed position, the spatulas are substantially coplanar and adjacent one another.

12. The stacker of claim 11 wherein each of the spatulas is triangular so as to form a single triangle substantially conforming to a shape and size of the first half-sandwich when the support wings are in their closed position.

13. The stacker of claim 1 further comprising a resiliently biased hold-down positioned to compress downwardly onto the first half-sandwich.

14. The stacker of claim 6 wherein the pair of support wings are selectively actuable between an open position removed from supporting the first half-sandwich, and a closed position supporting the first half-sandwich by the operation of at least one linear actuator.

15. The stacker of claim 4 wherein the rotator is positioned above the gripper and below the end of the positioning device.

16. The stacker of claim 1 wherein the rotator is adapted to provide a rotational acceleration profile which includes a reduced rotational acceleration at opposite ends of a rotational travel-path traveled by the gripper as it is rotated by the rotator from a first half-sandwich pick-up position to a first half-sandwich drop position.

17. The stacker of claim 1 wherein the rotator includes at least one shock absorber to reduce rotational acceleration at opposite ends of a rotational travel-path traveled by the gripper as it is rotated by the rotator from a first half-sandwich pick-up position to a first half-sandwich drop position.

18. The stacker of claim 1 wherein the selectively actuable rotator includes a robotic wrist.

19. The stacker of claim 1 wherein the selectively actuable rotator includes a combination of robotic wrist and separate rotator adapted to couple to an end of a positioning device having the robotic wrist.
